(19) United States
(12) Patent Application Publication
(10) Pub. No.: US 2026/0006387 A1
(43) Pub. Date: Jan. 1, 2026

(54) TRANSDUCER

(71) Applicant: Murata Manufacturing Co., Ltd., Nagaokakyo-shi (JP)

(72) Inventors: Hiroshi MATSUBARA, Nagaokakyo-shi (JP); Shinsuke Ikeuchi, Nagaokakyo-shi (JP); Ryosuke Niwa, Nagaokakyo-shi (JP); Gou Saitou, Nagaokakyo-shi (JP); Koichi Yoshida, Nagaokakyo-shi (JP)

(21) Appl. No.: 19/321,599

(22) Filed: Sep. 8, 2025

Related U.S. Application Data
(63) Continuation of application No. PCT/JP2023/043561, filed on Dec. 6, 2023.

(30) Foreign Application Priority Data
Apr. 26, 2023 (JP) 2023-072395

(51) Int. Cl. H04R 17/02; H04R 1/28; H04R 3/00

(52) U.S. Cl. CPC H04R 17/02; H04R 1/2807; H04R 3/00; H04R 2201/003

(57) ABSTRACT

A transducer is provided that includes a base having a cavity, and a vibrating layer disposed on an upper side of the base. The vibrating layer includes a fixed portion fixed to the base, and a membrane that is connected to the fixed portion and extends above the cavity. The vibrating layer includes a lower electrode layer connected to the base, a piezoelectric layer disposed on the lower electrode layer, and an upper electrode layer disposed on an upper side of the piezoelectric layer. In at least a portion of the membrane, the upper and lower electrode layers sandwich the piezoelectric layer. The upper electrode layer or the lower electrode layer includes a fixed electrode portion in the fixed portion, a movable electrode portion in a portion of the membrane, and a connection electrode portion that connects the fixed electrode portion to the movable electrode portion.

### CROSS REFERENCE TO RELATED APPLICATIONS

This application is a continuation of International Application No. PCT/JP2023/043561, filed Dec. 6, 2023, which claims priority to Japanese Patent Application No. Application No. 2023-072395, filed Apr. 26, 2023, the contents of each of which are hereby incorporated by reference in their entireties.

### TECHNICAL FIELD

The present disclosure relates to a transducer and can be used as a transmitter that emits sound waves and a sound receiver (e.g., a microphone) that receives sound waves. In particular, the exemplary aspects of the present disclosure relate to an ultrasonic wave transceiver configured to transmit and receive ultrasonic waves. Further, the exemplary aspects of the present disclosure relate to a piezoelectric transducer using a piezoelectric body.

### BACKGROUND

Japanese Unexamined Patent Application Publication No. 2021-52305 discloses the configuration of a transducer. The transducer described therein has a membrane support portion, a vibrating membrane, a piezoelectric element, and a dividing slit. The membrane support portion includes a cylindrical inner peripheral surface that forms a hollow portion. The vibrating membrane is connected to the inner peripheral surface over the entire circumference of the inner peripheral surface and is displaceable in the film thickness direction. The piezoelectric element includes a pair of electrodes, and a piezoelectric membrane sandwiched between the pair of electrodes, and is stacked on the vibrating membrane. The dividing slit passes through a vibrating body, which is obtained by stacking the vibrating membrane and the piezoelectric element, in the thickness direction to divide the vibrating body into a plurality of vibration regions.

In operation, the vibrating body has a resonant frequency. When the vibrating body deforms greatly at the resonant frequency, transmission sound pressure and reception sensitivity of the transducer increase. If the frequency characteristics of the transmission sound pressure and the reception sensitivity of the transducer have a steep peak at the resonant frequency, the usable frequency band will become narrow.

### SUMMARY OF THE INVENTION

In view of the foregoing, it is an object of the present disclosure to provide a transducer configured to make the frequency characteristics of the transmission sound pressure and the reception sensitivity into a frequency characteristic of a broad peak shape with a reduced Q value.

According to an exemplary aspect, a transducer is provided that includes a base having a cavity, and a vibrating layer disposed on an upper side of the base. The vibrating layer includes a fixed portion fixed to the base, and a membrane that is connected to the fixed portion and that extends above the cavity. The vibrating layer includes a lower electrode layer connected to the base, a piezoelectric layer disposed on an upper side of the lower electrode layer, and an upper electrode layer disposed on an upper side of the piezoelectric layer. In at least a portion of a region of the membrane portion, the upper electrode layer and the lower electrode layer sandwich the piezoelectric layer. The transducer further includes a first pad electrode and a second pad electrode. The first pad electrode is disposed on the fixed portion and is electrically connected to the upper electrode layer. The second pad electrode is disposed on the fixed portion and is electrically connected to the lower electrode layer without the piezoelectric layer interposed therebetween. The upper electrode layer or the lower electrode layer includes a fixed electrode portion located in the fixed portion, a movable electrode portion located on a portion of the membrane portion, and a connection electrode portion that connects the fixed electrode portion and the movable electrode portion to each other. Moreover, the connection electrode portion can be formed of a piezoresistive material.

According to the exemplary aspects of the present disclosure, the frequency characteristics of the transmission sound pressure and the reception sensitivity can be made into a frequency characteristic of a broad peak shape with a reduced Q value.

### BRIEF DESCRIPTION OF DRAWINGS

FIG. 1 is a plan view showing a configuration of a transducer according to a first Exemplary Embodiment 1.

FIG. 2 is a cross-sectional view of the transducer in FIG. 1 as viewed in the direction of the arrow line II-II.

FIG. 3 is a cross-sectional view showing a state in which a wafer is prepared in a method of manufacturing the transducer according to the first Exemplary Embodiment 1.

FIG. 4 is a cross-sectional view showing a state in which a piezoelectric layer is formed on a lower electrode layer in the method of manufacturing the transducer according to the first Exemplary Embodiment 1.

FIG. 5 is a cross-sectional view showing a state in which an upper electrode layer is formed on the piezoelectric layer in the method of manufacturing the transducer according to the first Exemplary Embodiment 1.

FIG. 6 is a cross-sectional view showing a state in which the upper electrode layer is patterned in the method of manufacturing the transducer according to the first Exemplary Embodiment 1.

FIG. 7 is a plan view of a multilayer body shown in FIG. 6 as viewed in the direction of the arrow line VII.

FIG. 8 is a simulation analysis diagram showing the distribution of a YZ component of a shear stress generated in a displaced membrane portion in the transducer according to the first Exemplary Embodiment 1.

FIG. 9 is a plan view showing a configuration of a transducer according to a second Exemplary Embodiment 2.

FIG. 10 is a plan view showing a configuration of a transducer according to a third Exemplary Embodiment 3.

FIG. 11 is a plan view showing a configuration of a transducer according to a modification of the third Exemplary Embodiment 3.

FIG. 12 is a schematic plan circuit diagram showing a configuration of a transducer according to a fourth Exemplary Embodiment 4.

FIG. 13 is a circuit diagram showing a configuration of a processing circuit of the transducer according to the fourth Exemplary Embodiment 4.

FIG. 14 is a graph showing the relationship between the difference in the electrical resistance value between piezoresistors R1 and R3 and piezoresistors R4 and R2 and an applied voltage to a piezoelectric layer in the transducer according to the fourth Exemplary Embodiment 4.

FIG. 15 is a schematic plan circuit diagram showing a configuration of a bridge circuit of a transducer according to a modification of the fourth Exemplary Embodiment 4.

FIG. 16 is a circuit diagram showing a configuration of a processing circuit of a transducer according to a fifth Exemplary Embodiment 5.

FIG. 17 is a graph showing the relationship between the difference in the electrical resistance value between piezoresistors R1 and R3 and piezoresistors R4 and R2 and a positive applied voltage to a piezoelectric layer in the transducer according to the fifth Exemplary Embodiment 5.

FIG. 18 is a graph showing the relationship between the difference in the electrical resistance value between the piezoresistors R1 and R3 and the piezoresistors R4 and R2 and a negative applied voltage to the piezoelectric layer in the transducer according to the fifth Exemplary Embodiment 5.

FIG. 19 is a plan view showing a configuration of a transducer according to a sixth Exemplary Embodiment 6.

FIG. 20 is a cross-sectional view showing a state in which an electrode portion is formed on a lower electrode layer in a method of manufacturing the transducer according to the sixth Exemplary Embodiment 6.

FIG. 21 is a cross-sectional view showing a state in which a piezoelectric layer is formed on the lower electrode layer in the method of manufacturing the transducer according to the sixth Exemplary Embodiment 6.

FIG. 22 is a cross-sectional view showing a state in which the piezoelectric layer is patterned in the method of manufacturing the transducer according to the sixth Exemplary Embodiment 6, as viewed in the direction of the arrow line A-A in FIG. 19.

FIG. 23 is a cross-sectional view showing a state in which the piezoelectric layer is patterned in the method of manufacturing the transducer according to the sixth Exemplary Embodiment 6, as viewed in the direction of the arrow line B-B in FIG. 19.

FIG. 24 is a cross-sectional view showing a state in which the lower electrode layer is patterned in the method of manufacturing the transducer according to the sixth Exemplary Embodiment 6, as viewed in the direction of the arrow line A-A in FIG. 19.

FIG. 25 is a cross-sectional view showing a state in which the lower electrode layer is patterned in the method of manufacturing the transducer according to the sixth Exemplary Embodiment 6, as viewed in the direction of the arrow line B-B in FIG. 19.

FIG. 26 is a cross-sectional view showing a state in which an upper electrode layer is formed on the piezoelectric layer in the method of manufacturing the transducer according to the sixth Exemplary Embodiment 6, as viewed in the direction of the arrow line A-A.

FIG. 27 is a cross-sectional view showing a state in which the upper electrode layer is formed on the piezoelectric layer in the method of manufacturing the transducer according to the sixth Exemplary Embodiment 6, as viewed in the direction of the arrow line B-B.

FIG. 28 is a cross-sectional view showing a state in which pad electrodes are formed in the method of manufacturing the transducer according to the sixth Exemplary Embodiment 6, as viewed in the direction of the arrow line A-A.

FIG. 29 is a cross-sectional view showing a state in which the pad electrodes are formed in the method of manufacturing the transducer according to the sixth Exemplary Embodiment 6, as viewed in the direction of the arrow line B-B.

### DETAILED DESCRIPTION OF EMBODIMENTS

Hereinafter, transducers according to each embodiment of the present disclosure will be described with reference to the drawings. In the description of the following embodiments, the same or equivalent components in the drawings are denoted by the same reference signs, and the description thereof will not be repeated. The transducer of the present disclosure is, for example, an acoustic MEMS element.

In this description, the term “MEMS” is an abbreviation of “Micro Electro Mechanical Systems”. The term “acoustic MEMS element” is a generic name for MEMS microphones, pMUTs (piezoelectric Micro-machined Ultrasonic Transducer) and MEMS speakers.

### Exemplary Embodiment 1

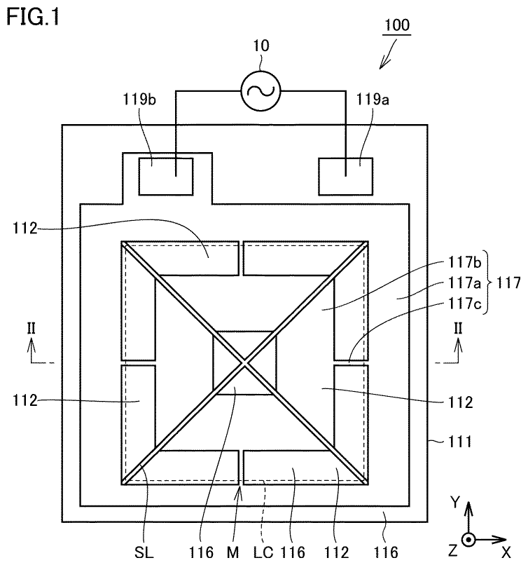

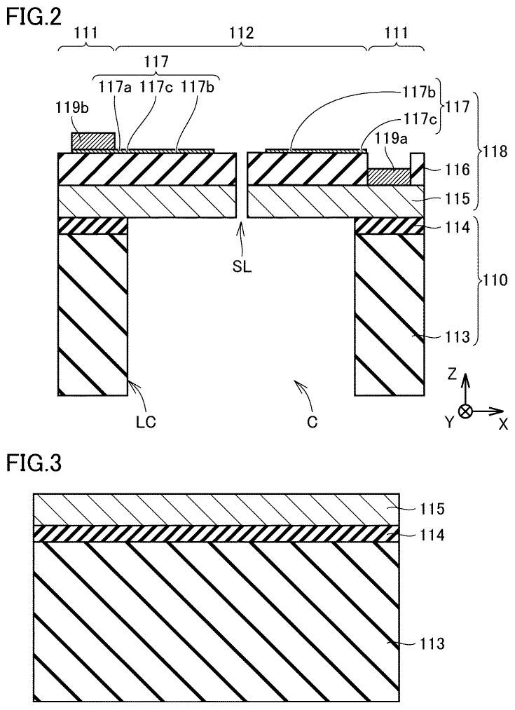

FIG. 1 is a plan view showing a configuration of a transducer according to a first Exemplary Embodiment 1 of the present disclosure. FIG. 2 is a cross-sectional view of the transducer in FIG. 1 as viewed in the direction of the arrow line II-II. For convenience of explanation, a first pad electrode and a second pad electrode, which are located at different cross sections, are shown in FIG. 2.

As shown in FIGS. 1 and 2, a transducer 100 according to Embodiment 1 includes a base portion 110 (also referred to as a “base”) having a cavity C, and a vibrating layer 118 disposed on the upper side of the base portion 110. In the present embodiment, as viewed in the stacking direction (Z-axis direction) of the base portion 110 and the vibrating layer 118, a peripheral surface LC of the cavity C has a square shape composed of two sides extending in the X-axis direction and two sides extending in the Y-axis direction. It is noted that the shape of the peripheral surface LC of the cavity C is not limited to a square shape, but may be a rectangle shape or another polygon shape as viewed in the stacking direction (Z-axis direction) as would be appreciated to one skilled in the art.

As shown in FIG. 2, the base portion 110 includes a substrate 113, and an oxide film 114 disposed on the upper side of the substrate 113. The vibrating layer 118 includes a fixed portion 111 fixed to the base portion 110, and a membrane portion 112 (also referred to as a “membrane”) that is connected to the fixed portion 111 that extends above the cavity C. In the present embodiment, the membrane portion 112 is divided into four parts by through-slits SL. As shown in FIG. 1, the through-slits SL are formed on the diagonal lines of the square shape of the peripheral surface LC as viewed in the stacking direction (Z-axis direction), and each of the four divided membrane portions 112 has a triangular shape.

As shown in FIG. 2, the vibrating layer 118 includes a lower electrode layer 115 connected to the base portion 110, a piezoelectric layer 116 disposed on the upper side of the lower electrode layer 115, and an upper electrode layer 117 disposed on the upper side of the piezoelectric layer 116. In at least a portion of the region of the membrane portion 112, the upper electrode layer 117 and the lower electrode layer 115 sandwich the piezoelectric layer 116.

As shown in FIGS. 1 and 2, the transducer 100 further includes a first pad electrode 119b and a second pad electrode 119a. The first pad electrode 119b is disposed on the fixed portion 111 and is electrically connected to the upper electrode layer 117. The second pad electrode 119a is disposed on the fixed portion 111 and is electrically connected to the lower electrode layer 115 without the piezoelectric layer 116 interposed therebetween. A voltage processing unit 10 is connected between the first pad electrode 119b and the second pad electrode 119a. The voltage processing unit 10 can apply a voltage between the first pad electrode 119b and the second pad electrode 119aand can take out a voltage between the first pad electrode 119b and the second pad electrode 119a.

The upper electrode layer 117 includes a fixed electrode portion 117a located in the fixed portion 111, a movable electrode portion 117b located in a portion of the membrane portion 112, and a connection electrode portion 117c that is located, in the membrane portion 112, at a position close to the fixed portion 111 and that connects the fixed electrode portion 117a and the movable electrode portion 117b to each other.

In the present embodiment, the fixed electrode portion 117a includes, as viewed in the stacking direction (Z-axis direction), a first portion located in a rectangular annular shape surrounding the membrane portion 112 and a second portion extending from the first portion so as to include the formation position of the first pad electrode 119b.

As viewed in the stacking direction (Z-axis direction), the movable electrode portion 117b is formed in a central portion of the membrane portion 112, excluding a tip portion opposite to the fixed portion 111 side and a root portion of the fixed portion 111 side. In the present embodiment, the movable electrode portion 117b formed in each membrane portion 112 has a trapezoidal shape sandwiched between two through-slits SL as viewed in the stacking direction (Z-axis direction). The movable electrode portion 117b is separated from the fixed electrode portion 117a.

In the present embodiment, the connection electrode portion 117c is formed in a thin line shape as viewed in the stacking direction (Z-axis direction). Here, the thin line shape means a shape that is narrowed so that the cross-sectional area (cross-sectional area along the Z-axis direction) of the flow path of the current flowing between the fixed electrode portion 117a and the movable electrode portion 117b becomes small. It is noted that the connection electrode portion 117c does not have to be formed in a thin line shape. In the present embodiment, the connection electrode portion 117c is formed in a straight line shape as viewed in the stacking direction (Z-axis direction). The connection electrode portion 117c is formed in the vicinity of a center position M of each side of the peripheral surface LC as viewed in the stacking direction (Z-axis direction).

The connection electrode portion 117c is formed of a piezoresistive material according to an exemplary aspect. The piezoresistive material is a material that exhibits a piezoresistance effect.

Here, a method of manufacturing the transducer 100 will be described below. FIG. 3 is a cross-sectional view showing a state in which a wafer is prepared in a method of manufacturing the transducer according to Embodiment 1. In the present embodiment, as shown in FIG. 3, an SOI (Silicon on Insulator) wafer is prepared. Specifically, the substrate 113 is a silicon substrate, the oxide film 114 is a SiO2 film which is a Box (Buried Oxide) layer, and the lower electrode layer 115 is a low-resistance active layer silicon. The active layer silicon may be either p-type or n-type, and the resistivity thereof is adjusted by a commonly used dopant such as boron, phosphorus, antimony, or arsenic. The wafer is not limited to silicon but may be formed of other semiconductor materials.

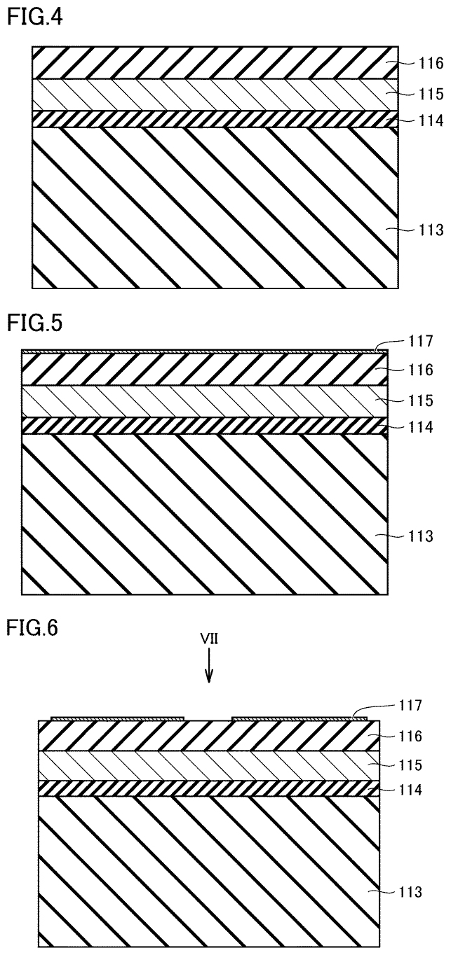

FIG. 4 is a cross-sectional view showing a state in which a piezoelectric layer is formed on a lower electrode layer in the method of manufacturing the transducer according to Embodiment 1. As shown in FIG. 4, the piezoelectric layer 116 is formed on the lower electrode layer 115. For example, a piezoelectric single crystal substrate can be bonded to the lower electrode layer 115 by surface activated bonding or atom diffusion bonding, and then the piezoelectric single crystal substrate can be thinned by grinding with a grinder or the like to form the piezoelectric layer 116. The material of the piezoelectric single crystal substrate may be any one selected from, for example, lithium tantalate (LiTaO3) (also called “LT”), lithium niobate (LiNbO3) (also called “LN”), and quartz.

As a method of thinning the piezoelectric single crystal substrate, in addition to grinding and polishing, there is another method in which a damaged layer is previously provided on the bonding surface side of the piezoelectric single crystal substrate by an ion implantation method, and then peeled off by the damaged layer after bonding. Further, such a method can be combined with polishing. Alternatively, the piezoelectric layer 116 can be formed by forming a piezoelectric thin film such as lead zirconate titanate (PZT) using a sol-gel method or a sputtering method, for example.

FIG. 5 is a cross-sectional view showing a state in which an upper electrode layer is formed on the piezoelectric layer in the method of manufacturing the transducer according to Embodiment 1. As shown in FIG. 5, the upper electrode layer 117 is formed on the piezoelectric layer 116. For example, the upper electrode layer 117 can be formed by bonding a crystal substrate having a large piezoresistance coefficient to the piezoelectric layer 116 by surface activated bonding or atom diffusion bonding, and then thinning the crystal substrate by grinding with a grinder or the like. The method of thinning the crystal substrate is the same as the method of thinning the piezoelectric single crystal substrate described above.

Examples of the crystal substrate having a large piezoresistance coefficient include, for example, a p-type silicon substrate having a large piezoresistance coefficient (Π₄₄) related to shear stress. Specifically, the piezoresistance coefficient (Π₄₄) of the p-type silicon is 138.1×10⁻¹¹ (Pa⁻¹).

TABLE 1

| | | | Piezoresistance | Piezoresistance |
|---|---|---|---|---|
| | Crystal | Crystal | coefficient | coefficient |
| | direction in | direction in | (π_{L}) in | (π_{T}) in |
| Crystal | X-axis | Y-axis | X-axis | Y-axis |
| plane | direction | direction | direction | direction |
| (110) | <111> | <211> | +0.66 π₄₄ | +0.33 π₄₄ |
| (110) | <110> | <001> | +0.5 π₄₄ | ~0 |
| (100) | <110> | <110> | +0.5 π₄₄ | −0.5 π₄₄ |
| (100) | <100> | <100> | +0.02 π₄₄ | +0.02 π₄₄ |

Table 1 summarizes the piezoresistance coefficients of a rectangular p-type silicon substrate having an X-axis direction and a Y-axis direction. It is noted that the relationship between the crystal direction and the X-axis direction and the Y-axis direction is not limited to that described above and may be different. As shown in Table 1, in the p-type silicon substrate, the following 3 examples are exemplified as combinations of crystal planes and crystal directions having a large piezoresistance coefficient (Π_{L}) in the X-axis direction.

A p-type silicon substrate in which a crystal plane (110) is located on the main surface, a crystal direction in the X-axis direction is <111>, and a crystal direction in the Y-axis direction is <211>. A p-type silicon substrate in which the crystal plane (110) is located on the main surface, a crystal direction in the X-axis direction is <110>, and a crystal direction in the Y-axis direction is <001>. A p-type silicon substrate in which a crystal plane (100) is located on the main surface, a crystal direction in the X-axis direction is <110>, and a crystal direction in the Y-axis direction is <110>.

As another method of forming the upper electrode layer 117, a polycrystalline thin film or an amorphous thin film having a relatively large piezoresistance coefficient can be formed by a plasma CVD (chemical vapor deposition) method or the like. For example, a p-type silicon polycrystalline thin film formed by adding boron can be exemplified. As further another method of forming the upper electrode layer 117, a metal thin film having a relatively large piezoresistance coefficient, such as nickel, can be formed by a sputtering method, a vapor deposition method, or the like.

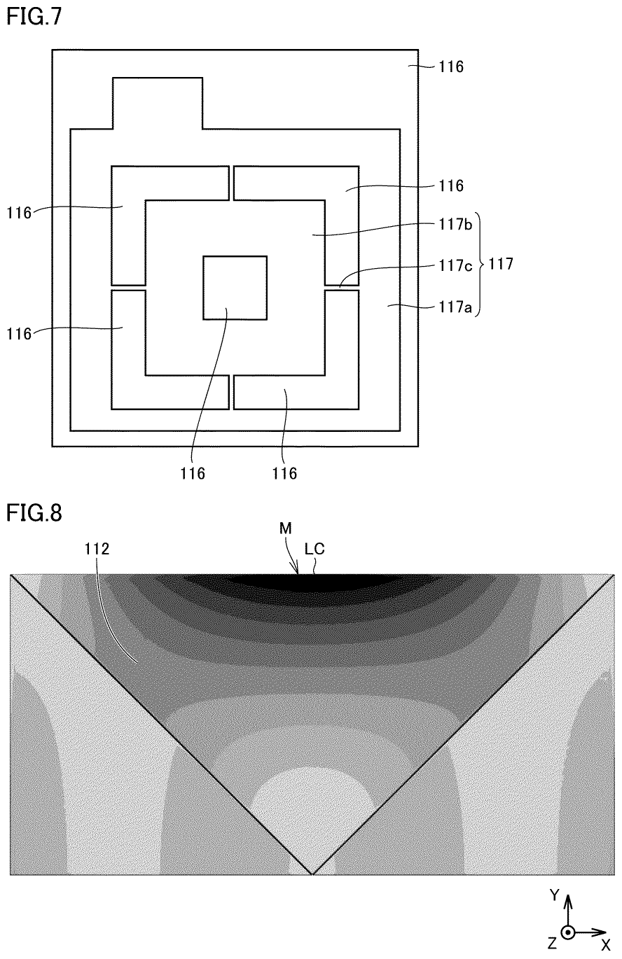

FIG. 6 is a cross-sectional view showing a state in which the upper electrode layer is patterned in the method of manufacturing the transducer according to Embodiment 1. FIG. 7 is a plan view of a multilayer body illustrated in FIG. 6 as viewed in the direction of the arrow line VII. As illustrated in FIGS. 6 and 7, the upper electrode layer 117 is patterned to a desired shape. The patterning can be performed by, for example, dry etching such as reactive ion etching (also referred to as “RIE”). As viewed in the stacking direction (Z-axis direction), the peripheral portion of each side of the peripheral surface LC of the upper electrode layer 117 is patterned into thin line by patterning. As viewed in the stacking direction (Z-axis direction), the connection electrode portion 117c in a thin line shape is formed in the periphery of each side of the peripheral surface LC. In the present embodiment, the connection electrode portion 117c in a thin line shape is formed so as to be located in the vicinity of the center position of each side of the peripheral surface LC as viewed in the stacking direction (Z-axis direction).

Next, the piezoelectric layer 116 is patterned to a desired shape. Specifically, the piezoelectric layer 116 may be subjected to dry etching such as RIE or subjected to wet etching using fluoric acid or the like.

Next, the lower electrode layer 115 is patterned to a desired shape by dry etching. As a result, slits corresponding to the through-slits SL are formed in the membrane portion 112.

Next, the first pad electrode 119b and the second pad electrode 119a are formed at desired positions. The first pad electrode 119b is formed so as to lie on the upper surface of the upper electrode layer 117. The second pad electrode 119a is formed so as to lie on the upper surface of the lower electrode layer 115.

Preferably, the material of the first pad electrode 119b and the second pad electrode 119a is a material configured to make ohmic contact with the material forming the upper electrode layer 117. Each of the first pad electrode 119b and the second pad electrode 119a may be formed by stacking, for example, an adhesion layer, a barrier layer, and a surface electrode layer in this order. The adhesion layer is made of, for example, Ti, and has a thickness of 0.005 μm or thicker and 0.1 μm or thinner. The barrier layer is made of, for example, Pt, and has a thickness of 0.005 μm or thicker and 0.1 μm or thinner. The surface electrode layer is made of, for example, Au, and has a thickness of 0.1 μm or thicker and 1.0 μm or thinner. The first pad electrode 119b and the second pad electrode 119a are formed to have a desired pattern by a vapor deposition lift-off method. The first pad electrode 119b and the second pad electrode 119a may be formed by forming a film over the entire surface by sputtering and then forming a desired pattern by an etching method.

Next, the substrate 113 is removed to become a desired shape by DRIE (deep reactive ion etching), and then part of the oxide film 114 is removed by RIE to form the cavity C, and the membrane portion 112 is divided into four parts by the through-slits SL.

The transducer 100 according to Embodiment 1 as shown in FIGS. 1 and 2 is manufactured by the above process.

FIG. 8 is a simulation analysis diagram showing the distribution of a YZ component of shear stress generated in the displaced membrane portion in the transducer according to Embodiment 1. In the four divided membrane portions 112, when only one membrane portion 112 was displaced, a simulation analysis was performed on the distribution of the YZ component of the shear stress generated in such a membrane portion 112.

As shown in FIG. 8, in the transducer 100 according to the present embodiment, when the membrane portion 112 is displaced, the YZ component of the shear stress generated in the membrane portion 112 is maximum in the vicinity of the center position M of each side of the peripheral surface LC as viewed in the stacking direction (Z-axis direction). That is, the shear stress generated in the center portion of the width of the root portion of the membrane portion 112 is maximum.

In the transducer 100 according to the present embodiment, the larger the displacement amount of the membrane portion 112, the larger the resistance change due to the piezoresistance effect, so that the voltage drop in the connection electrode portion 117c increases. Thus, when the transducer 100 transmits signals, the displacement of the membrane portion 112 is suppressed at the peak portion of the frequency characteristic, and when the transducer 100 receives signals, the voltage value taken out by the voltage processing unit 10 at the peak portion of the frequency characteristic is reduced. When the connection electrode portion 117c is formed at the position where the maximum shear stress occurs when the membrane portion 112 is displaced, the resistance change due to the piezoresistance effect can be made larger.

Due to the above action, in the transducer 100 according to the present embodiment, the effect of suppressing the peak portion of the frequency characteristics of the transmission sound pressure and the reception sensitivity appears, so that a frequency characteristic of a broad peak shape can be obtained with a reduced Q value. Therefore, the usable frequency band of the transducer 100 can be widened.

Further, since the applied voltage to the piezoelectric layer 116 can be reduced at the resonant frequency at which the membrane portion 112 tends to be displaced, the driving voltage can be increased over the entire frequency band, so that the transmission sound pressure in the frequency band deviated from the resonant frequency can be increased.

Specific examples will be described below. Assuming that the driving voltage is 12 Vpp, the resistance value R of the connection electrode portion 117c is adjusted so that the voltage drop at the connection electrode portion 117c becomes 6V when the membrane portion 112 is not displaced. When the resistance change value of the connection electrode portion 117c becomes ΔR due to the piezoresistance effect when the membrane portion 112 is displaced, the voltage drop at the connection electrode portion 117c becomes 6×(1+ΔR/R). The ΔR increases as the displacement of the membrane portion 112 increases and thereby the stress generated in the connection electrode portion 117c increases, and the voltage value applied to the piezoelectric layer 116 decreases accordingly.

Since the transmission sound pressure of the transducer 100 has a proportional correlation with the voltage applied to the piezoelectric layer 116, the voltage is relatively less likely to be applied to the piezoelectric layer 116 at the frequencies at which the membrane portion 112 tends to be displaced, and as a result, a frequency characteristic of a broad peak shape can be obtained. Similarly, in the case of reception, at the frequencies at which the membrane portion 112 tends to be displaced and the reception sensitivity is high, since ΔR increases and the voltage drop at the connection electrode portion 117c increases, the voltage taken out by the voltage processing unit 10 becomes relatively small, so that the frequency characteristic of the reception sensitivity becomes a broad peak shape.

In the transducer 100 according to the present embodiment, the connection electrode portion 117c is formed in a thin line shape. Thus, a large voltage drop value at the connection electrode portion 117c due to the piezoresistance effect when the membrane portion 112 is displaced can be secured. As a result, the frequency characteristics of the transmission sound pressure and the reception sensitivity can be effectively made into a frequency characteristic of a broad peak shape with a reduced Q value.

In the transducer 100 according to the present embodiment, a portion of the connection electrode portion 117c is located, in the membrane portion 112, at a position close to the fixed portion 111. At such a position, the maximum shear stress occurs when the membrane portion 112 is displaced. Thus, a large voltage drop value at the connection electrode portion 117c due to the piezoresistance effect when the membrane portion 112 is displaced can be secured. As a result, the frequency characteristics of the transmission sound pressure and the reception sensitivity can be effectively made into a frequency characteristic of a broad peak shape with a reduced Q value.

In the transducer 100 according to the present embodiment, the piezoresistive material is a single crystal. Thus, since the piezoresistive material of the single crystal has a large piezoresistance coefficient, a large voltage drop value at the connection electrode portion 117c due to the piezoresistance effect when the membrane portion 112 is displaced can be secured. As a result, the frequency characteristics of the transmission sound pressure and the reception sensitivity can be effectively made into a frequency characteristic of a broad peak shape with a reduced Q value.

When the piezoelectric layer 116 is formed by forming a piezoelectric thin film, the step of bonding the piezoelectric single crystal substrate to the lower electrode layer 115 and thinning the piezoelectric single crystal substrate can be eliminated, so that the transducer 100 can be manufactured by a simple process.

### Exemplary Embodiment 2

Hereinafter, a transducer according to a second Exemplary Embodiment 2 will be described with reference to the drawings. The transducer according to Embodiment 2 has a different pattern shape of the connection electrode portion from the transducer according to Embodiment 1. Therefore, the description of the same configurations as those of the transducer according to Embodiment 1 will not be repeated.

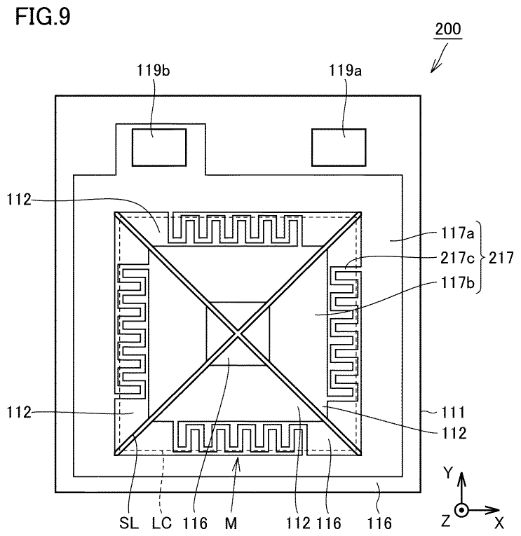

FIG. 9 is a plan view showing a configuration of the transducer according to Embodiment 2. As shown in FIG. 9, in a transducer 200 according to Embodiment 2, an upper electrode layer 217 includes a fixed electrode portion 117a located in the fixed portion 111, a movable electrode portion 117b located in a portion of the membrane portion 112, and a connection electrode portion 217c that is located, in the membrane portion 112, at a position close to the fixed portion 111 and that connects the fixed electrode portion 117a and the movable electrode portion 117b to each other.

In the present embodiment, the connection electrode portion 217c is formed in a meander shape when viewed from the stacking direction (Z-axis direction). Specifically, the connection electrode portion 217c is formed so that a plurality of folded portions is connected along the peripheral surface LC of the cavity C when viewed from the stacking direction (Z-axis direction).

In the present embodiment, since the effective length of the connection electrode portion 217c can be increased, a large voltage drop value at the connection electrode portion 217c due to the piezoresistance effect when the membrane portion 112 is displaced can be secured. As a result, the frequency characteristics of the transmission sound pressure and the reception sensitivity can be effectively made into a frequency characteristic of a broad peak shape with a reduced Q value.

Further, since the area of the piezoelectric layer 116 sandwiched between the connection electrode portion 217c and the lower electrode layer 115 can be increased, and particularly since the covering area of the connection electrode portion 217c located, in the membrane portion 112, at a position close to the fixed portion 111 can be increased in which the driving force for displacing the membrane portion 112 can be effectively increased, the driving force for displacing the membrane portion 112 can be increased as compared with Embodiment 1, so that the transmission sound pressure and reception sensitivity of the transducer 200 can be increased.

### Exemplary Embodiment 3

Hereinafter, a transducer according to a third Exemplary Embodiment 3 will be described with reference to the figures. The transducer according to Embodiment 3 has a different pattern shape of the movable electrode portion and the connection electrode portion from the transducer 200 according to Embodiment 2. Therefore, the description of the same configurations as those of the transducer 200 according to Embodiment 2 will not be repeated.

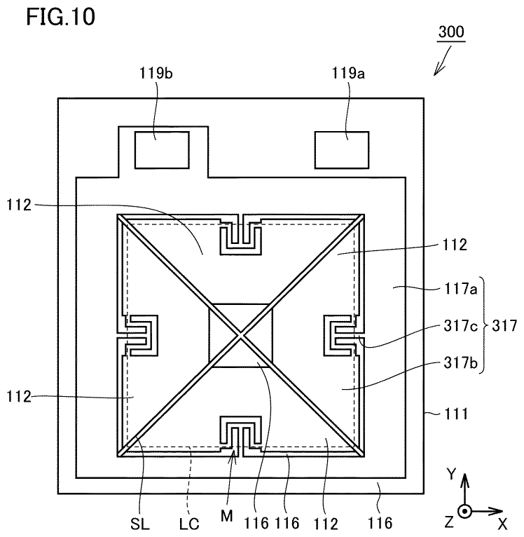

FIG. 10 is a plan view showing a configuration of the transducer according to Embodiment 3. As shown in FIG. 10, in a transducer 300 according to Embodiment 3, an upper electrode layer 317 includes a fixed electrode portion 117a located in the fixed portion 111, a movable electrode portion 317b located in a portion of the membrane portion 112, and a connection electrode portion 317c that is located, in the membrane portion 112, at a position close to the fixed portion 111 and that connects the fixed electrode portion 117a and the movable electrode portion 317b to each other.

In the present embodiment, the connection electrode portion 317c is formed in the vicinity of the center position M of each side of the peripheral surface LC when viewed in the stacking direction (Z-axis direction). In the connection electrode portion 317c, a folded portion is formed linearly symmetrically about a straight line shaped extension portion extending linearly from the fixed electrode portion 117a.

The movable electrode portion 317b extends, in the membrane portion 112, from a tip side opposite to the fixed portion 111 side to a position close to the fixed portion 111. Specifically, as viewed in the stacking direction (Z-axis direction), the movable electrode portion 317b is formed in the central portion of the membrane portion 112, and the entire portion of the root portion of the membrane portion 112 other than the region where the connection electrode portion 317c is formed. A portion of the movable electrode portion 317b is located, in the membrane portion 112, at a position close to the fixed portion 111. Thus, since the area of the piezoelectric layer 116 sandwiched between the movable electrode portion 317b, the connection electrode portion 317c, and the lower electrode layer 115 can be increased, and particularly since the covering area of the movable electrode portion 317b located, in the membrane portion 112, at a position close to the fixed portion 111 can be increased in which the driving force for displacing the membrane portion 112 can be effectively increased, the driving force for displacing the membrane portion 112 can be increased as compared with Embodiment 1 and Embodiment 2, so that the transmission sound pressure and reception sensitivity of the transducer 300 can be increased.

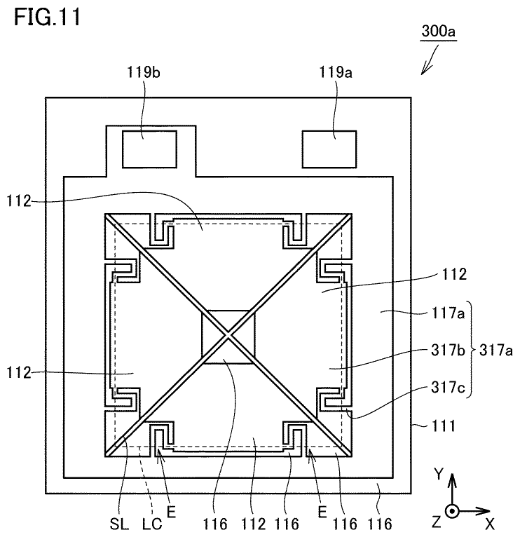

FIG. 11 is a plan view showing a configuration of a transducer according to a modification of Embodiment 3. As shown in FIG. 11, in an upper electrode layer 317a of a transducer 300a according to the modification of Embodiment 3, a connection electrode portion 317c is formed so as to have one folded portion in the vicinity of both end portions E of each side of the peripheral surface LC when viewed in the stacking direction (Z-axis direction). As viewed in the stacking direction (Z-axis direction), the movable electrode portion 317b is formed in a region sandwiched between the central portion of the membrane portion 112 and two regions where the connection electrode portion 317c is formed in the root portion. A portion of the movable electrode portion 317b is located, in the membrane portion 112, at a position close to the fixed portion 111. Thus, since the area of the piezoelectric layer 116 sandwiched between the movable electrode portion 317b, the connection electrode portion 317c, and the lower electrode layer 115 can be increased, the transmission sound pressure and reception sensitivity of the transducer 300a can be increased by increasing the driving force for displacing the membrane portion 112, particularly by increasing the covering area of the movable electrode portion 317b located, in the membrane portion 112, at a position close to the fixed portion 111 in which the driving force for displacing the membrane portion 112 is effectively increased.

### Exemplary Embodiment 4

Hereinafter, a transducer according to a fourth Exemplary Embodiment 4 will be described with reference to the drawings. The transducer according to Embodiment 4 is different from the transducer 100 according to Embodiment 1 in that the transducer is provided with a processing circuit in which a bridge circuit to which a plurality of piezoresistors of the connection electrode portions are connected is formed. Therefore, the description of the same configurations as those of the transducer 100 according to Embodiment 1 will not be repeated.

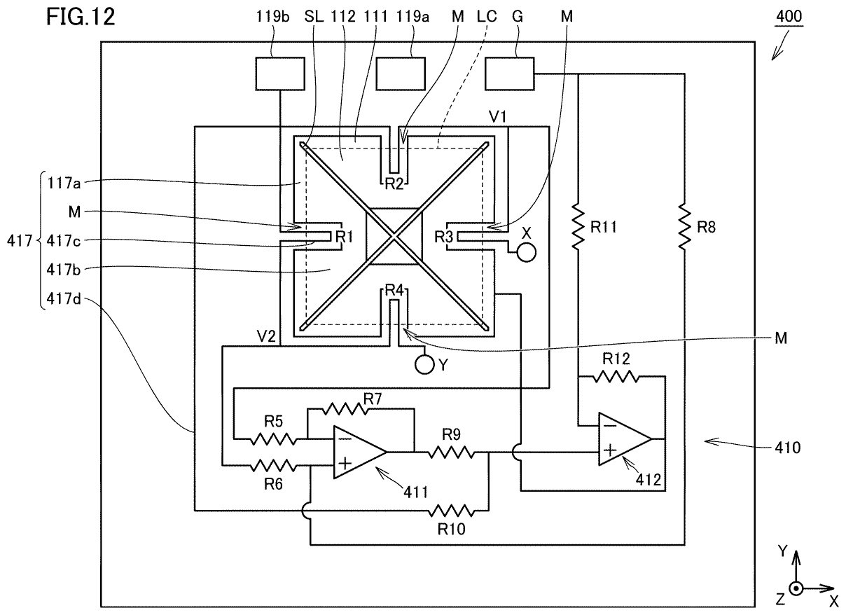

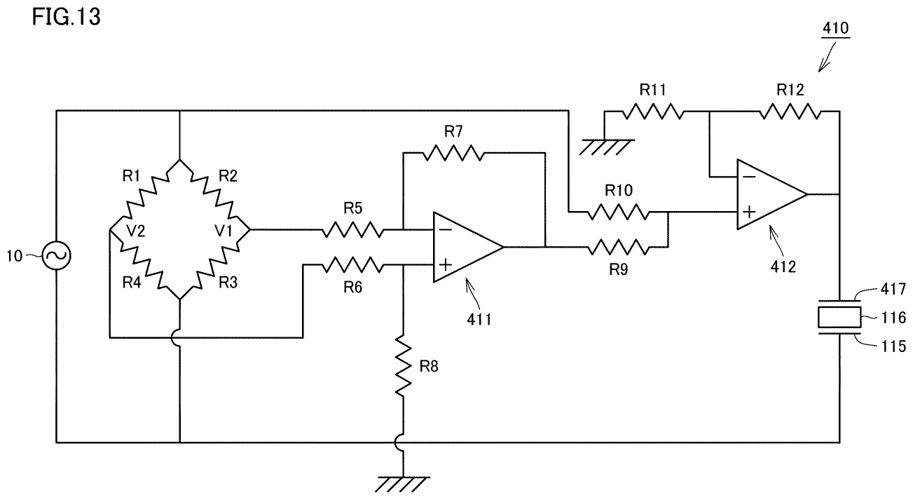

FIG. 12 is a schematic plan circuit diagram showing a configuration of the transducer according to Embodiment 4. FIG. 13 is a circuit diagram showing a configuration of the processing circuit of the transducer according to Embodiment 4. In FIG. 12, the shape of an upper electrode layer 417 is simplified and schematically illustrated in order to explain a configuration of the bridge circuit.

As shown in FIG. 12, in a transducer 400 according to Embodiment 4, an upper electrode layer 417 includes a fixed electrode portion 117a located in the fixed portion 111, a movable electrode portion 417b located in a portion of the membrane portion 112, a connection electrode portion 417c that is located, in the membrane portion 112, at a position close to the fixed portion 111 and that connects the fixed electrode portion 117a and the movable electrode portion 417b to each other, and a wiring portion 417d.

The wiring portion 417d is a connection wiring line in a processing circuit 410 and is formed in a thick line shape so as to increase the current flow path area. Further, a metal film may be formed only on the wiring portion 417d so as to reduce the electrical resistance value of the wiring portion 417d.

As shown in FIGS. 12 and 13, the transducer 400 further includes the processing circuit 410. In the present embodiment, the processing circuit 410 is formed in a MEMS element in which the transducer 400 is formed, but the processing circuit 410 may be formed in another element such as an ASIC (application specific integrated circuit).

A plurality of piezoresistors R1 to R4 of the connection electrode portion 417c are connected to the processing circuit 410 to form a bridge circuit. The piezoresistors R1 to R4 each correspond to the connection electrode portion 417c formed in a corresponding one of the four divided membrane portions 112.

In the processing circuit 410, a voltage calculated from a driving voltage applied between the first pad electrode 119b and the second pad electrode 119a and an output voltage (V1, V2) of the bridge circuit is applied to the piezoelectric layer 116.

In the present embodiment, in the processing circuit 410, the output voltage (V1, V2) of the bridge circuit is differentially amplified in a polarity opposite to the driving voltage, and a voltage obtained by adding the differentially amplified output voltage of the bridge circuit and the driving voltage is applied to the piezoelectric layer 116. Specifically, the processing circuit 410 includes a differential amplifier circuit 411 connected to the bridge circuit, and an adder circuit 412 connected to the voltage processing unit 10 and the differential amplifier circuit 411. The differential amplifier circuit 411 includes an operational amplifier and resistors R5 to R8. The adder circuit 412 includes an operational amplifier and resistors R9 to R12. In the differential amplifier circuit 411, the output voltage (V1, V2) of the bridge circuit is differentially amplified in a polarity opposite to the driving voltage. The differentially amplified output voltage of the bridge circuit and the driving voltage applied from the voltage processing unit 10 are added in the adder circuit 412, and the added voltage is applied to the piezoelectric layer 116.

As shown in FIG. 12, the piezoresistor R1 and the piezoresistor R2 are connected to the first pad electrode 119b and become high potential due to the voltage applied from the voltage processing unit 10. Connecting vias X and Y shown in FIG. 12 are formed in the piezoelectric layer 116 and electrically connect the upper electrode layer 417 and the lower electrode layer 115. The piezoresistor R3 and the piezoresistor R4 are connected to the second pad electrode 119a via the connecting vias X and Y and the lower electrode layer 115 and become low potential due to the voltage applied from the voltage processing unit 10.

The piezoresistors R1 to R4 are formed so that when the membrane portion 120 is not displaced, the piezoresistors R1 to R4 have the same electrical resistance value, and when the membrane portion 120 is displaced, due to the piezoresistance effect, the electrical resistance value of each of the piezoresistor R1 and the piezoresistor R3 are increased and the electrical resistance value of each of the piezoresistor R2 and the piezoresistor R4 are decreased.

In order to increase the output voltage (|V1|−|V2|) of the bridge circuit, the piezoresistance coefficient (Π_{L}) in the X-axis direction must be larger than the piezoresistance coefficient (Π_{T}) in the Y-axis direction, and the electrical resistance values of the piezoresistor R1 and the piezoresistor R3 must be larger than the electrical resistance values of the piezoresistor R2 and the piezoresistor R4. Therefore, in the present embodiment, the upper electrode layer 117 is formed of a p-type silicon substrate in which a crystal plane (100) is located on the main surface, a crystal direction in the X-axis direction is <110>, and a crystal direction in the Y-axis direction is <110>, as shown in Table 1.

When the shear stress in the X-axis direction is σ_{L} and the shear stress in the Y-axis direction is σ_{T}, the specific resistance change (ΔR/R) satisfies the relation ΔR/R=Π_{L}σ_{L}×Π_{T}σ_{T}.

In the present embodiment, since the upper electrode layer 117 is formed of a p-type silicon substrate, each of the piezoresistor R1 and the piezoresistor R3 is formed so that the electrical resistance value becomes higher from R to R+ΔR when the membrane portion 120 is displaced and the piezoresistance effect appears, and each of the piezoresistor R2 and the piezoresistor R4 is formed so that the electrical resistance value becomes lower from R to R−ΔR when the membrane portion 120 is displaced and the piezoresistance effect appears. Therefore, in the bridge circuit, a midpoint potential V2 at the connection position between the piezoresistor R1 and the piezoresistor R4 and a midpoint potential V1 at the connection position between the piezoresistor R2 and the piezoresistor R3 satisfy the relationship of |V1|>|V2|.

The degree of suppression of the voltage applied to the piezoelectric layer 116 when the membrane portion 120 is displaced the most can be adjusted by setting the electrical resistance value of each of the resistors R5 to R8 in the differential amplifier circuit 411.

The magnitude of the voltage applied to the piezoelectric layer 116 can be adjusted by setting the electrical resistance value of each of the resistors R9 to R12 in the adder circuit 412. For example, if the electrical resistance values of each of the resistors R9 to R12 are all made equal, the result is obtained by performing a simple addition; if the electrical resistance values of the resistor R9 and the resistor R10 are made equal to each other while the electrical resistance value of the resistor R12 is made larger than the electrical resistance value of the resistor R11, the voltage applied to the piezoelectric layer 116 can be increased even if the driving voltage is small. In such a case, the amplification factor of the voltage is (R11+R12)/(2R11).

In the present embodiment, the adder circuit 412 is a non-adder circuit in which the polarity of the input voltage and the polarity of the output voltage are the same. However, it is noted that the adder circuit 412 is not limited to a non-adder circuit, but may alternatively be an inverted adder circuit in which the polarity of the input voltage and the polarity of the output voltage are opposite to each other, particularly in the case of bipolar drive.

If the processing circuit 410 is formed in another element such as an ASIC, a desired voltage can be applied to the piezoelectric layer 116 by, for example, outputting the midpoint potentials V1 and V2 of the bridge circuit to the ASIC, and applying an applied voltage to the piezoelectric layer 116 to the upper electrode layer 417, in which the applied voltage to the piezoelectric layer 116 is calculated in the ASIC with V1, V2, (V1−V2) and the like as parameters. In such a case, for example, an equation configured for calculating the applied voltage to the piezoelectric layer 116 according to the value of (V1−V2) is stored in the ASIC.

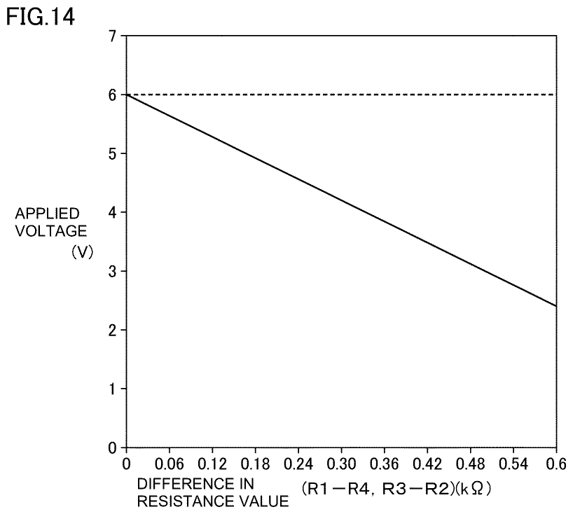

FIG. 14 is a graph showing the relationship between the difference in the electrical resistance value between the piezoresistors R1 and R3 and the piezoresistors R4 and R2 and the applied voltage to the piezoelectric layer in the transducer according to Embodiment 4. In FIG. 14, the vertical axis represents the applied voltage (V) to the piezoelectric layer, and the horizontal axis represents the difference in the electrical resistance value (R1−R4, R3−R2) (kΩ). In FIG. 14, the driving voltage is indicated by a dotted line, and the applied voltage to the piezoelectric layer is indicated by a solid line. The electrical resistance values of the resistors R5, R6, R9, R10, R11, and R12 are 5 kΩ. The electrical resistance values of the resistors R7 and R8 are 75 kΩ.

As shown in FIG. 14, the applied voltage to the piezoelectric layer 116 decreases as the difference in the electrical resistance value between the piezoresistor R1 and the piezoresistor R4, and the difference in the electrical resistance value between the piezoresistor R3 and the piezoresistor R2 increases due to the piezoresistance effect when the membrane portion 112 is displaced. That is, the applied voltage to the piezoelectric layer 116 when the membrane portion 120 is displaced the most can be suppressed.

In the present embodiment, the effect of suppressing the applied voltage to the piezoelectric layer 116 due to the piezoresistance effect when the membrane portion 112 is displaced can be increased by setting the amplification factor in the differential amplifier circuit 411. As a result, the frequency characteristics of the transmission sound pressure and the reception sensitivity can be effectively made into a frequency characteristic of a broad peak shape with a reduced Q value.

Further, even if a material having a relatively low piezoresistance coefficient is used as the constituent material of the upper electrode layer 417, the effect of suppressing the applied voltage to the piezoelectric layer 116 due to the piezoresistance effect when the membrane portion 112 is displaced can be secured by setting the amplification factor in the differential amplifier circuit 411, so that the degree of freedom of selection of the constituent material of the upper electrode layer 417 can be increased.

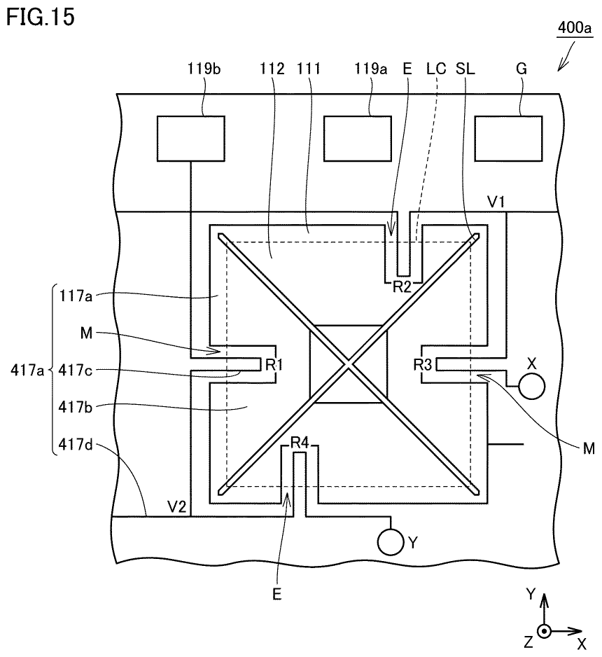

FIG. 15 is a schematic plan circuit diagram showing a configuration of a bridge circuit of a transducer according to a modification of Embodiment 4. As shown in FIG. 15, in a transducer 400a according to the modification of Embodiment 4, an upper electrode layer 417a includes a fixed electrode portion 117a located in the fixed portion 111, a movable electrode portion 417b located in a portion of the membrane portion 112, a connection electrode portion 417c that is located, in the membrane portion 112, at a position close to the fixed portion 111 and that connects the fixed electrode portion 117a and the movable electrode portion 417b to each other, and a wiring portion 417d.

In the present modification, a material in which the piezoresistance coefficient (Π_{L}) in the X-axis direction is equal to the piezoresistance coefficient (Π_{T}) in the Y-axis direction is used as the material forming the upper electrode layer 117. For example, as shown in Table 1, the upper electrode layer 117 is formed of a p-type silicon substrate in which a crystal plane (100) is located on the main surface, a crystal direction in the X-axis direction is <100>, and a crystal direction in the Y-axis direction is <100>.

Each of the piezoresistor R1 and the piezoresistor R3 is disposed in the vicinity of the center position M of a corresponding side of the peripheral surface LC, and each of the piezoresistor R2 and the piezoresistor R4 is disposed in the vicinity of an end portion E of a corresponding side of the peripheral surface LC. The shear stresses σ_{L} and σ_{T} in the Z-axis direction generated in the displaced membrane portion 112 are smaller in the vicinity of the end portion E of each side of the peripheral surface LC than in the vicinity of the center position M of each side of the peripheral surface LC. As described above, since the specific resistance change (ΔR/R) in the connection electrode portion 417c satisfies the relation ΔR/R=Π_{L}σ_{L}×Π_{T}σ_{T}, by disposing the piezoresistors R2 and R4 in the vicinity of the end portion E while disposing the piezoresistors R1 and R3 in the vicinity of the center position M, it is possible to make the resistance change value of the piezoresistors R2 and R4 smaller than the resistance change value of the piezoresistors R1 and R3 when the membrane portion 112 is displaced, so that the difference in the electrical resistance value between the piezoresistor R1 and the piezoresistor R4 and the difference in the electrical resistance value between the piezoresistor R3 and the piezoresistor R2 can be secured. That is, regardless of the difference between the piezoresistance coefficient (Π_{L}) and the piezoresistance coefficient (Π_{T}), the difference in the electrical resistance value (R1−R4, R3−R2) can be secured due to the difference in the shear stresses σ_{L} and σ_{T} caused by the difference in the arrangement of the connection electrode portion 417c. By amplifying the difference in the electrical resistance value (R1−R4, R3−R2) in the differential amplifier circuit 411, the effect of suppressing the applied voltage to the piezoelectric layer 116 when the membrane portion 112 is displaced can be secured as in Embodiment 4.

Thus, the degree of freedom of selection of the constituent material of the upper electrode layer 417 can be increased. In the present modification, the material forming the upper electrode layer 117 is not limited to a material in which the piezoresistance coefficient (Π_{L}) in the X-axis direction and the piezoresistance coefficient (Π_{T}) in the Y-axis direction are equal to each other, and may be a material in which the difference between the piezoresistance coefficient (Π_{L}) and the piezoresistance coefficient (Π_{T}) is relatively small. Further, the upper electrode layer 417 may be formed by using a piezoresistive material in which the difference between the piezoresistance coefficient (Π_{L}) and the piezoresistance coefficient (Π_{T}) is relatively large. In such a case, the output voltage (V1, V2) of the bridge circuit can be increased to increase the effect of suppressing the applied voltage to the piezoelectric layer 116 when the membrane portion 120 is displaced the most.

### Exemplary Embodiment 5

A transducer according to a fifth Exemplary Embodiment 5 will be described below with reference to the figures. The transducer according to Embodiment 5 differs from the transducer 400 according to Embodiment 4 in that an additional resistor is connected to the bridge circuit. Therefore, the description of the same configurations as those of the transducer 400 according to Embodiment 4 will not be repeated.

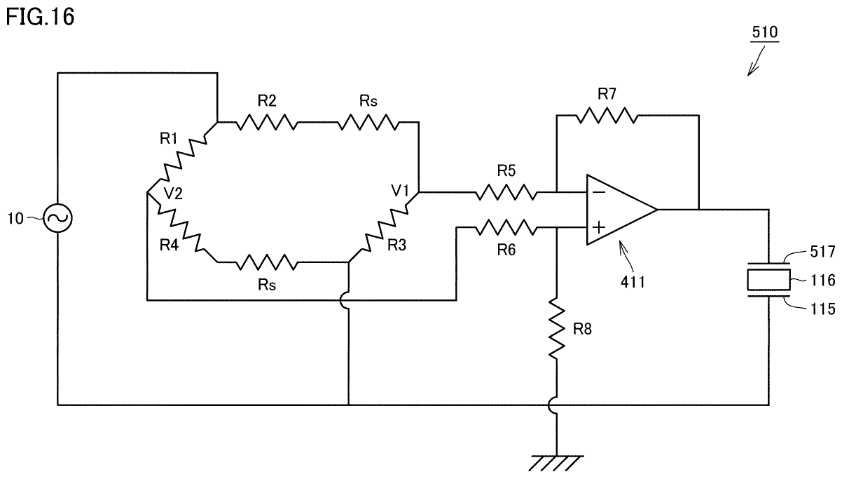

FIG. 16 is a circuit diagram showing a configuration of a processing circuit of the transducer according to Embodiment 5. As shown in FIG. 16, the transducer according to Embodiment 5 includes a processing circuit 510. The processing circuit 510 includes a bridge circuit to which a plurality of piezoresistors R1 to R4 are connected, and a differential amplifier circuit 411.

The plurality of piezoresistors R1 to R4 include the piezoresistors R1 and R3 having relatively large resistance values when the membrane portion 112 is displaced, and the piezoresistors R2 and R4 having relatively small resistance values when the membrane portion 112 is displaced. In the bridge circuit, an additional resistor Rs is connected in series to, among the plurality of piezoresistors R1 to R4, the piezoresistors R2 and R4 having relatively small resistance values when the membrane portion 112 is displaced. In the processing circuit 510, a voltage obtained by differentially amplifying the output voltage (V1, V2) of the bridge circuit is applied to a piezoelectric layer 116 between an upper electrode layer 517 and the lower electrode layer 115.

Preferably, the electrical resistance value of the additional resistor Rs is slightly larger than the difference in the electrical resistance value (R1−R4) between the piezoresistor R1 and the piezoresistor R4 and the difference in the electrical resistance value (R3−R2) between the piezoresistor R3 and the piezoresistor R2, respectively, at the time when the membrane portion 112 is maximally displaced. In such a case, since the midpoint potentials V1 and V2 shown in FIG. 16 satisfy the relationship of |V1|<|V2| and the value of (V1−V2) has a polarity opposite to the driving voltage Vin, the differential amplifier circuit 411 is an inverting amplifier circuit; so that the voltage applied to the piezoelectric layer 116 is made to have the same polarity as the driving voltage Vin.

Specifically, the resistance change value of the piezoresistors R1 to R4 at the time when the membrane portion 112 is maximally displaced is ΔRmax, each of the piezoresistor R1 and the piezoresistor R3 is formed so that the electrical resistance value becomes higher from R to R+ΔRmax when the membrane portion 120 is maximally displaced and the piezoresistance effect appears, and each of the piezoresistor R2 and the piezoresistor R4 is formed so that the electrical resistance value becomes lower from R to R−ΔRmax when the membrane portion 120 is displaced and the piezoresistance effect appears.

The value of (V1−V2) when the membrane portion 112 is not displaced is Vin×(−Rs)/(2R+Rs). The value of (V1−V2) when the membrane portion 112 is maximally displaced is Vin×(2ΔRmax−Rs)/(2R+Rs). Therefore, the ratio of the applied voltage to the piezoelectric layer 116 at the resonant frequency (at the time when the membrane portion 112 is maximally displaced) to the applied voltage to the piezoelectric layer 116 at the time when the membrane portion 112 is not displaced is (2ΔRmax−Rs)/(−Rs).

Therefore, the degree of suppression of the applied voltage to the piezoelectric layer 116 at the resonant frequency (at the time when the membrane portion 112 is maximally displaced) can be adjusted by setting the electrical resistance value of the additional resistor Rs.

It is noted that, when Rs=2ΔRmax, since the applied voltage to the piezoelectric layer 116 becomes 0 at the resonant frequency (at the time when the membrane portion 112 is maximally displaced), as described above, it is preferable that the electrical resistance value of the additional resistor Rs is slightly larger than the difference in the electrical resistance value (R1−R4) between the piezoresistor R1 and the piezoresistor R4 and the difference in the electrical resistance value (R3−R2) between the piezoresistor R3 and the piezoresistor R2, respectively, at the time when the membrane portion 112 is maximally displaced.

In the transducer according to Embodiment 5, it is possible to effectively make, with a smaller circuit having reduced number of operational amplifiers as compared to Embodiment 4, the frequency characteristics of the transmission sound pressure and the reception sensitivity into a frequency characteristic of a broad peak shape with a reduced Q value. Further, by appropriately setting the electrical resistance values of the resistors R5 to R8 and the additional resistor Rs, the value of (V1−V2) when the membrane portion 112 is not displaced can be made larger as compared to Embodiment 4, so that the transmission sound pressure in the frequency band deviated from the resonant frequency can be increased.

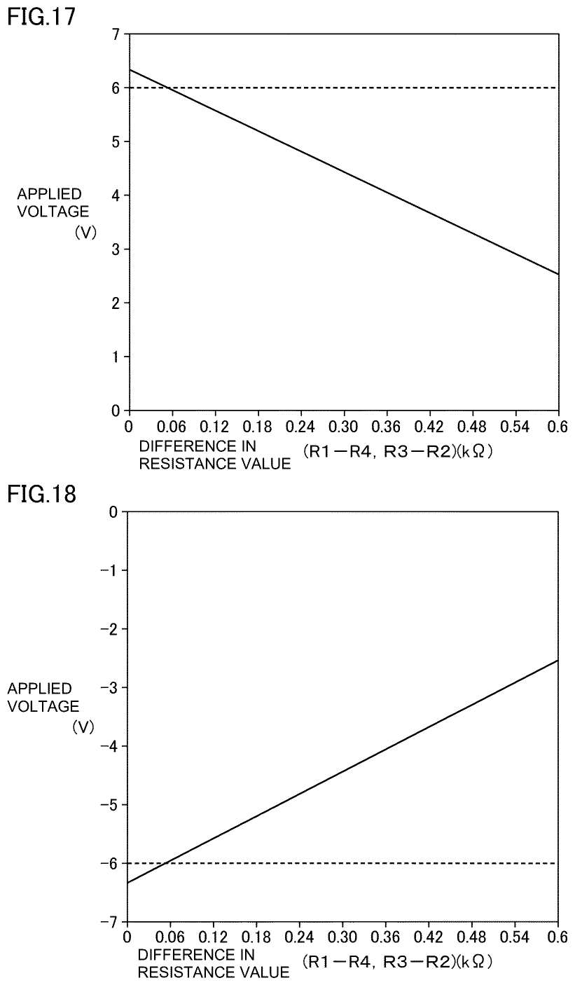

FIG. 17 is a graph showing the relationship between the difference in the electrical resistance value between the piezoresistors R1 and R3 and the piezoresistors R4 and R2 and a positive applied voltage to the piezoelectric layer in the transducer according to Embodiment 5. In FIG. 17, the vertical axis represents the applied voltage (V) to the piezoelectric layer, and the horizontal axis represents the difference in the electrical resistance value (R1−R4, R3−R2) (kΩ). In FIG. 17, the driving voltage is indicated by a dotted line, and the applied voltage to the piezoelectric layer is indicated by a solid line. The electrical resistance values of the resistors R5 and R6 are 5 kΩ. The electrical resistance values of the resistors R7 and R8 are 90 kΩ. The electrical resistance value of the additional resistor Rs is 1 kΩ.

As shown in FIG. 17, when the polarity of the driving voltage Vin is positive, the applied voltage to the piezoelectric layer 116 decreases as the difference in the electrical resistance value between the piezoresistor R1 and the piezoresistor R4 and the difference in the electrical resistance value between the piezoresistor R3 and the piezoresistor R2 increase due to the piezoresistance effect when the membrane portion 112 is displaced. That is, the applied voltage to the piezoelectric layer 116 when the membrane portion 120 is displaced the most can be suppressed.

FIG. 18 is a graph showing the relationship between the difference in the electrical resistance value between the piezoresistors R1 and R3 and the piezoresistors R4 and R2 and a negative applied voltage to the piezoelectric layer in the transducer according to Embodiment 5. In FIG. 18, the vertical axis represents the applied voltage (V) to the piezoelectric layer, and the horizontal axis represents the difference in the electrical resistance value (R1−R4, R3−R2) (kΩ). In FIG. 18, the driving voltage is indicated by a dotted line, and the applied voltage to the piezoelectric layer is indicated by a solid line. The electrical resistance values of the resistors R5 and R6 are 5 kΩ. The electrical resistance values of the resistors R7 and R8 are 90 kΩ. The electrical resistance value of the additional resistor Rs is 1 kΩ.

As shown in FIG. 18, even when the polarity of the driving voltage Vin is negative, the absolute value of the applied voltage to the piezoelectric layer 116 decreases as the difference in the electrical resistance value between the piezoresistor R1 and the piezoresistor R4 and the difference in the electrical resistance value between the piezoresistor R3 and the piezoresistor R2 increases due to the piezoresistance effect when the membrane portion 112 is displaced,

That is, the applied voltage to the piezoelectric layer 116 when the membrane portion 120 is displaced the most can be suppressed.

### Exemplary Embodiment 6

Hereinafter, the transducer according to a sixth Exemplary Embodiment 6 will be described with reference to the drawings. The transducer according to Embodiment 6 differs from the transducer according to Embodiment 1 in that the lower electrode layer, instead of the upper electrode layer, includes the fixed electrode portion, the movable electrode portion, and the connection electrode portion; therefore, the description of the same configurations as those of the transducer according to Embodiment 1 will not be repeated.

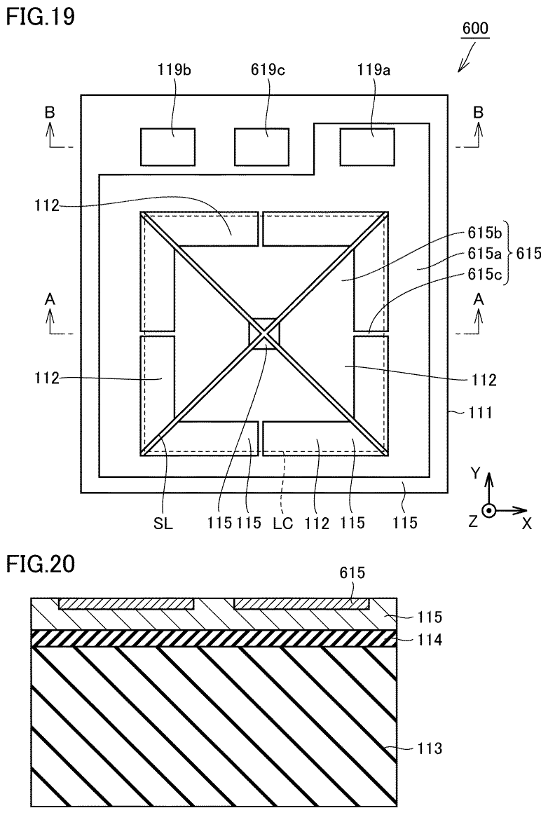

FIG. 19 is a plan view showing a configuration of the transducer according to Embodiment 6. As shown in FIG. 19, in a transducer 600 according to Embodiment 6, an electrode portion 615 is formed in a lower electrode layer 115, in which electrode portion 615 includes a fixed electrode portion 615a located at the fixed portion 111, a movable electrode portion 615b located in a portion of the membrane portion 112, and a connection electrode portion 615c that is located, in the membrane portion 112, at a position close to the fixed portion 111 and that connects the fixed electrode portion 615a and the movable electrode portion 615b to each other. The transducer 600 further includes a third pad electrode 619c. The third pad electrode 619c is disposed on the fixed portion 111 and is electrically connected to the lower electrode layer 115 without the piezoelectric layer 116 and the electrode portion 615 interposed therebetween.

Here, the method of manufacturing the transducer 600 will be described. In the present embodiment, as shown in FIG. 3, an SOI (Silicon on Insulator) wafer is prepared as shown in FIG. 3. In the present embodiment, the lower electrode layer 115 is n-type high-resistance active layer silicon. The active layer silicon may be either p-type or n-type, and the resistivity thereof is adjusted by a commonly used dopant such as boron, phosphorus, antimony, or arsenic. The wafer is not limited to silicon but may be formed of other semiconductor materials.

FIG. 20 is a cross-sectional view showing a state in which an electrode portion is formed on a lower electrode layer in a method of manufacturing the transducer according to Embodiment 6. As shown in FIG. 20, a p-type electrode portion 615 including the connection electrode portion 615c is formed by adding a piezoresistive material to a n-type active layer silicon, which is the lower electrode layer 115, in a desired pattern into the lower electrode layer 115 by an ion implantation method or a diffusion method. As viewed in the stacking direction (Z-axis direction), the pattern shape of the electrode portion 615 including the connection electrode portion 615c is similar to, for example, the pattern shape of the upper electrode layer in any one of Embodiments 1 to 5. A protective film such as a SiO2 film or the like may be formed on the surface of the active layer silicon on which the electrode portion 615 is formed.

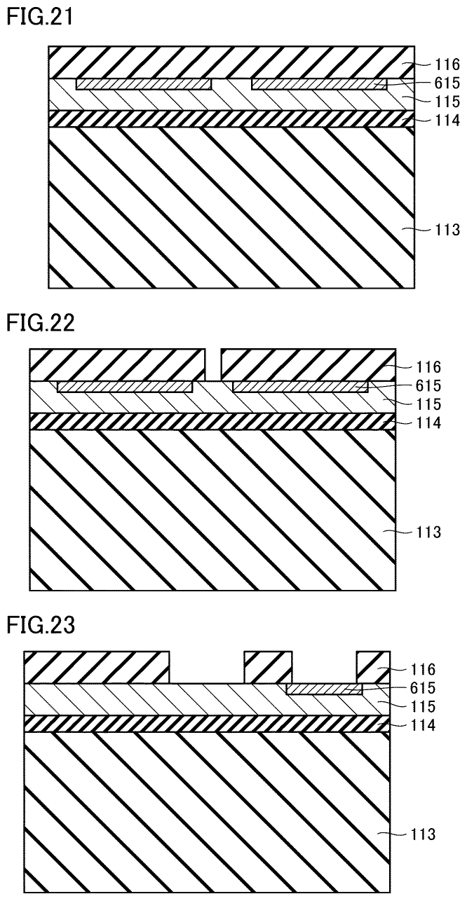

FIG. 21 is a cross-sectional view showing a state in which a piezoelectric layer is formed on the lower electrode layer in the method of manufacturing the transducer according to Embodiment 6. As shown in FIG. 21, a piezoelectric layer 116 is formed on the lower electrode layer 115 on which the electrode portion 615 is formed. The method of forming the piezoelectric layer 116 is the same as in Embodiment 1.

FIG. 22 is a cross-sectional view showing a state in which the piezoelectric layer is patterned in the method of manufacturing the transducer according to Embodiment 6, as viewed in the direction of the arrow line A-A in FIG. 19. FIG. 23 is a cross-sectional view showing a state in which the piezoelectric layer is patterned in the method of manufacturing the transducer according to Embodiment 6, as viewed in the direction of the arrow line B-B in FIG. 19.

As shown in FIGS. 22 and 23, the piezoelectric layer 116 is patterned to a desired shape. Specifically, dry etching such as RIE or the like may be performed, or wet etching using fluoric acid or the like may be performed. At this time, in order to be able to apply a voltage to the n-type active layer silicon, the piezoelectric layer 116 is also etched at a position where the third pad electrode 619c electrically connected to the n-type active layer silicon is to be formed.

The reason for making it able to apply a voltage to the n-type active layer silicon is that, when a driving voltage higher than the Fermi level difference between the p-type silicon and the n-type silicon is applied to the p-type electrode portion 615, leakage may occur at the p-n junction; therefore, a structure is designed in which the potential of the n-type active layer silicon can be controlled so that a depletion layer is always formed relative to the driving voltage (AC).

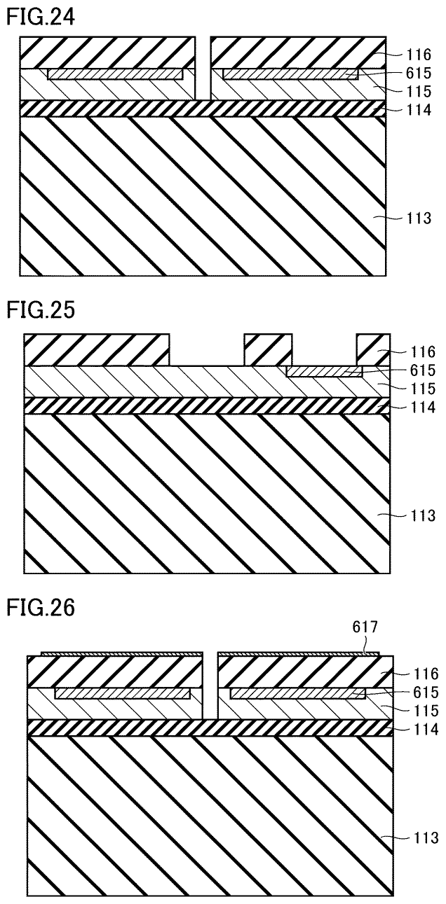

FIG. 24 is a cross-sectional view showing a state in which the lower electrode layer is patterned in the method of manufacturing the transducer according to Embodiment 6, as viewed in the direction of the arrow line A-A in FIG. 19. FIG. 25 is a cross-sectional view showing a state in which the lower electrode layer is patterned in the method of manufacturing the transducer according to Embodiment 6, as viewed in the direction of the arrow line B-B in FIG. 19.

As shown in FIGS. 24 and 25, the lower electrode layer 115 is patterned to a desired shape by dry etching. As a result, slits corresponding to the through-slits SL are formed in the membrane portion 112.

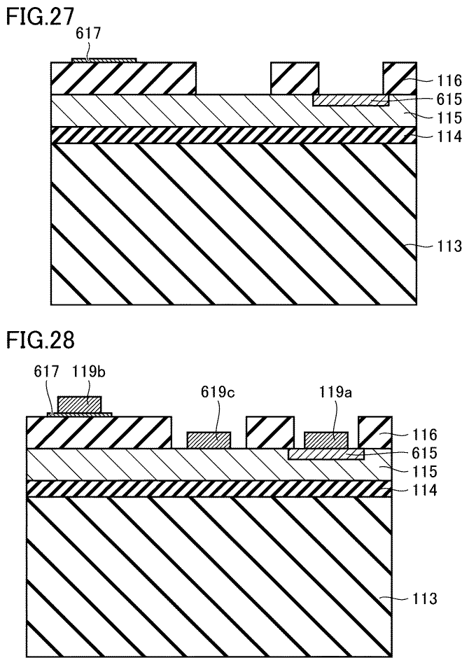

FIG. 26 is a cross-sectional view showing a state in which an upper electrode layer is formed on the piezoelectric layer in the method of manufacturing the transducer according to Embodiment 6, as viewed in the direction of the arrow line A-A. FIG. 27 is a cross-sectional view showing a state in which the upper electrode layer is formed on the piezoelectric layer in the method of manufacturing the transducer according to Embodiment 6, as viewed in the direction of the arrow line B-B.

As shown in FIGS. 26 and 27, an upper electrode layer 617 is formed on the piezoelectric layer 116. The material forming the upper electrode layer 617 is preferably a material configured to make ohmic contact with the material forming the piezoelectric layer 116. The material forming the upper electrode layer 617 is, for example, Pt. However, it should be appreciated that other materials such as Al may also be used. Further, an adhesion layer may be formed before forming the upper electrode layer 617. The material forming the adhesion layer may be, for example, Ti. However, it should be appreciated that other materials such as NiCr may also be used. The thickness of the upper electrode layer 617 is 0.05 μm or thicker and 0.2 μm or thinner, and the thickness of the adhesion layer is 0.005 μm or thicker and 0.05 μm or thinner. The upper electrode layer 617 is formed to have a desired pattern by a vapor deposition lift-off method. The upper electrode layer 617 may be formed by forming a film over the entire surface by sputtering and then forming a desired pattern by an etching method.

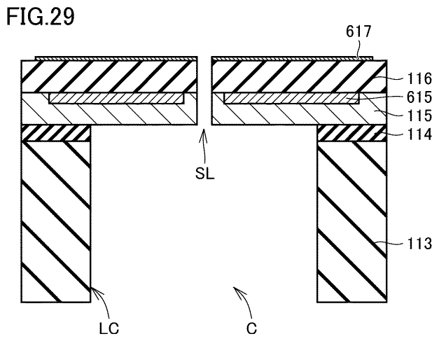

FIG. 28 is a cross-sectional view showing a state in which pad electrodes are formed in the method of manufacturing the transducer according to Embodiment 6, as viewed in the direction of the arrow line A-A. FIG. 29 is a cross-sectional view showing a state in which the pad electrodes are formed in the method of manufacturing the transducer according to Embodiment 6, as viewed in the direction of the arrow line B-B.

As shown in FIGS. 28 and 29, the first pad electrode 119b, the second pad electrode 119a, and the third pad electrode 619c are formed. The material forming the first pad electrode 119b, the second pad electrode 119a, and the third pad electrode 619c is preferably a material configured to make ohmic contact with the material forming the upper electrode layer 617. Each of the first pad electrode 119b, the second pad electrode 119a, and the third pad electrode 619c may be formed by stacking, for example, an adhesion layer, a barrier layer, and a surface electrode layer in this order. The adhesion layer is made of, for example, Ti or NiCr, and has a thickness of 0.005 μm or thicker and 0.1 μm or thinner. The barrier layer is made of, for example, Pt or Al, and has a thickness of 0.005 μm or thicker and 0.1 μm or thinner. The surface electrode layer is made of, for example, Au, and has a thickness of 0.1 μm or thicker and 1.0 μm or thinner. The first pad electrode 119b, the second pad electrode 119a and the third pad electrode 619c are formed to have a desired pattern by a vapor deposition lift-off method. The first pad electrode 119b, the second pad electrode 119a and the third pad electrode 619c may be formed by forming a film over the entire surface by sputtering and then forming a desired pattern by an etching method.

Next, the substrate 113 is removed to become a desired shape by DRIE, and then part of the oxide film 114 is removed by RIE to form a cavity C, and the membrane portion 112 is divided into four parts by the through-slits SL.

The transducer 600 according to Embodiment 6 as shown in FIG. 19 is manufactured by the above process.

In the transducer 600 according to Embodiment 6, the connection electrode portion 615c is formed in a thin line shape. Thus, a large voltage drop value at the connection electrode portion 615c due to the piezoresistance effect when the membrane portion 112 is displaced can be secured. As a result, the frequency characteristics of the transmission sound pressure and the reception sensitivity can be effectively made into a frequency characteristic of a broad peak shape with a reduced Q value.

In the transducer 600 according to Embodiment 6, since the electrode portion 615 including the connection electrode portion 615c is formed by adding the piezoresistive material into the lower electrode layer 115 in a desired pattern by an ion implantation method or a diffusion method, the step of bonding and thinning the piezoelectric single crystal substrate can be eliminated, so that the transducer 600 can be manufactured by a simple process.

In general, it is noted that in the description of the embodiments described above, combinable configurations may be combined with each other.

### REFERENCE SIGNS LIST

10 voltage processing unit
100, 200, 300, 300a, 400, 400a, 600 transducer
110 base portion
111 fixed portion
112, 120 membrane portion
113 substrate
114 oxide film
115 lower electrode layer
116 piezoelectric layer
117, 217, 317, 317a, 417, 417a, 517, 617 upper electrode layer
117a, 615a fixed electrode portion
117b, 317b, 417b, 615b movable electrode portion
117c, 217c, 317c, 417c, 615c connection electrode portion
118 vibrating layer
119a second pad electrode
119b first pad electrode
410, 510 processing circuit
411 differential amplifier circuit
412 adder circuit
417d wiring portion
615 electrode portion
619c third pad electrode
C cavity
E end portion
LC peripheral surface
M center position
R1, R2, R3, R4 piezoresistor
R5, R8, R9, R10, R11, R12 resistor
Rs additional resistor
SL through-slit
V1, V2 midpoint potential
X, Y connecting via

1. A transducer comprising:
a base having a cavity; and
a vibrating layer disposed on an upper side of the base, the vibrating layer including a fixed portion fixed to the base, and a membrane that is connected to the fixed portion and that extends above the cavity,
wherein the vibrating layer further includes a lower electrode layer connected to the base, a piezoelectric layer disposed on an upper side of the lower electrode layer, and an upper electrode layer disposed on an upper side of the piezoelectric layer, such that in at least a portion of the membrane, the upper electrode layer and the lower electrode layer sandwich the piezoelectric layer,
wherein the transducer further comprises:
a first pad electrode disposed on the fixed portion and electrically connected to the upper electrode layer; and
a second pad electrode disposed on the fixed portion and electrically connected to the lower electrode layer without the piezoelectric layer interposed therebetween, and
wherein the upper electrode layer or the lower electrode layer includes a fixed electrode portion located in the fixed portion, a movable electrode portion located in a portion of the membrane, and a connection electrode portion that connects the fixed electrode portion to the movable electrode portion.

2. The transducer according to claim 1, wherein the connection electrode portion comprises a piezoresistive material.

3. The transducer according to claim 1, wherein the connection electrode portion comprises a thin line shape.

4. The transducer according to claim 1, wherein the connection electrode portion comprises a meander shape.

5. The transducer according to claim 1, wherein a portion of the movable electrode portion is located, in the membrane, at a position adjacent to the fixed portion.

6. The transducer according to claim 1, wherein a portion of the connection electrode portion is located, in the membrane, at a position adjacent to the fixed portion.

7. The transducer according to claim 6, wherein the portion of the connection electrode portion is located, in the membrane, at the position adjacent to the fixed portion, at the position where a maximum shear stress occurs when the membrane is displaced.

8. The transducer according to claim 1, further comprising a processing circuit that includes a bridge circuit that is connected to a plurality of piezoresistors of the connection electrode portion.

9. The transducer according to claim 8, wherein, in the processing circuit, a voltage is applied to the piezoelectric layer, the voltage being calculated from a driving voltage applied between the first pad electrode and the second pad electrode and an output voltage of the bridge circuit.

10. The transducer according to claim 9, wherein, in the processing circuit, the output voltage of the bridge circuit is differentially amplified in a polarity opposite to the driving voltage.

11. The transducer according to claim 10, wherein a voltage is applied to the piezoelectric layer that is obtained by adding the differentially amplified output voltage of the bridge circuit and the driving voltage.

12. The transducer according to claim 9, wherein the plurality of piezoresistors include a piezoresistor having relatively large resistance value when the membrane is displaced and a piezoresistor having relatively small resistance value when the membrane is displaced.

13. The transducer according to claim 12, wherein, in the bridge circuit, an additional resistor is connected in series to the piezoresistor having the relatively small resistance value when the membrane is displaced.

14. The transducer according to claim 13, wherein, in the processing circuit, a voltage is applied to the piezoelectric layer that is obtained by differentially amplifying the output voltage of the bridge circuit.

15. The transducer according to claim 1, wherein the piezoresistive material is a single crystal.

16. The transducer according to claim 1, further comprising a slit that extends through at least the lower electrode layer and the piezoelectric layer.

17. The transducer according to claim 1, wherein the second pad electrode is disposed in a space that extends into the piezoelectric layer.

18. A transducer comprising:
a base having a cavity; and
a vibrating layer coupled to the base and including a fixed portion fixed to the base, and a membrane that extends over the cavity,
wherein the vibrating layer comprises includes a lower electrode layer connected to the base, a piezoelectric layer on the lower electrode layer, and an upper electrode layer on the piezoelectric layer, such that the lower and upper electrode layers sandwich the piezoelectric layer,
wherein a first pad electrode is disposed on the fixed portion of the vibrating layer and is electrically connected to the upper electrode layer, and
wherein a second pad electrode is disposed on the fixed portion of the vibrating layer and is electrically connected to the lower electrode layer without the piezoelectric layer interposed therebetween, and
wherein at least one of the upper electrode layer and the lower electrode layer includes a fixed electrode portion located in the fixed portion, a movable electrode portion located in a portion of the membrane, and a connection electrode portion that connects the fixed electrode portion to the movable electrode portion.

19. The transducer according to claim 18, wherein the connection electrode portion comprises a piezoresistive material.

20. The transducer according to claim 18, wherein:
a slit extends through at least the lower electrode layer and the piezoelectric layer, and
the second pad electrode is disposed in a space that extends into the piezoelectric layer.
